(19) United States
(12) Patent Application Publication
(10) Pub. No.: US 2011/0262704 A1
(43) Pub. Date: Oct. 27, 2011

(54) FLAME RESISTANT COMPOSITE FABRICS

(76) Inventors: Moshe Rock, Brookline, MA (US); Gadalia Vainer, Melrose, MA (US); Shawn Flavin, Sandown, NH (US); Heidi Carlone, Hooksett, NH (US); Michael Batson, Windham, NH (US)

(21) Appl. No.: 13/045,799

(22) Filed: Mar. 11, 2011

Related U.S. Application Data
(60) Provisional application No. 61/326,369, filed on Apr. 21, 2010.

(51) Int. Cl. B32B 3/00; D03D 15/12; B32B 5/26

(52) U.S. Cl. 428/156; 428/221; 428/340; 442/302

(57) ABSTRACT

A flame resistant composite fabric includes a first flame resistant fabric layer, a second flame resistant fabric layer, and a barrier layer that bonds the first flame resistant fabric layer to the second flame resistant fabric layer. The barrier layer is capable of withstanding temperature of 500° F. for at least 5 minutes without substantial change in the integrity of the flame resistant composite fabric.

This application claims benefit from U.S. Provisional Application No. 61/326,369, filed Apr. 21, 2010.

### TECHNICAL FIELD

This disclosure relates to flame resistant composite fabrics for use in safety apparel.

### BACKGROUND

Individuals working in environments where there is a risk of a flash fire need to wear flame resistant protective apparel. Example occupations include, but are not limited to, petrochemical and gas workers, industrial workers, and fire service personnel who seek to wear flame resistant apparel underneath their turnout gear or as a stand-alone garment for use in applications outside structural firefighting.

Individuals working near energized electrical equipment are exposed to potential risk from electric arc flash hazards which can occur from an arc flash event. Electrical arcs are formed in air when potential difference (i.e., voltage) between two electrodes causes atoms in the air to ionize and become able to conduct electricity.

### SUMMARY

In general, this disclosure relates to flame resistant composite fabrics for use in safety apparel.

In one aspect, a flame resistant composite fabric includes a first flame resistant fabric layer, a second flame resistant fabric layer, and a barrier layer that bonds the first flame resistant fabric layer to the second flame resistant fabric layer. The barrier layer is capable of withstanding temperature of 500° F. for at least 5 minutes without substantial change in the integrity of the flame resistant composite fabric.

In another aspect, a flame resistant composite fabric includes a first flame resistant fabric layer, a second flame resistant fabric layer, and a barrier layer that bonds the first flame resistant fabric layer to the second flame resistant fabric layer. The flame resistant composite fabric offers protection from electric arc flash hazards and/or from flash fire hazards in accordance with one or more of the following Nation Fire Protection Association standards: NFPA 70E (2009 ed.), NFPA 1975 (2009 ed.), NFPA 1977 (2005 ed.), NFPA 1951 (2007 ed.), and NFPA 2112 (2007 ed.).

In yet another aspect, a flame resistant composite fabric includes a first flame resistant fabric layer, a second flame resistant fabric layer, and a barrier layer that bonds the first flame resistant fabric layer to the second flame resistant fabric layer. The barrier layer includes an adhesive (e.g., a polyurethane-based adhesive) that includes a flame retardant additive system. The flame retardant additive system includes a brominated aromatic chemical (e.g., decabromodiphenyl oxide (DBDPO), penta bromo phenyl, etc.).

Embodiments of this disclosure may include one or more of the following additional features. At least one of the first flame resistant fabric layer and the second flame resistant fabric layer is formed of inherent flame resistant fibers, yarns, and/or fabric. At least one of the first flame resistant fabric layer and the second flame resistant fabric layer is formed of flame resistant treated fibers, yarns, and/or fabric. At least one of the first flame resistant fabric layer and the second flame resistant fabric layer is formed of flame resistant (FR) treated cotton, flame resistant treated cotton/nylon fiber blends, meta-aramid, and/or para-aramid fibers, yarns, and/or fabric. At least one of the first flame resistant fabric layer and the second flame resistant fabric layer is formed of modacrylic fibers, yarns, and/or fabric alone, or in a blend with one of more of flame resistant (FR) treated cotton, flame resistant treated cotton/nylon fiber blends, meta-aramid, and/or para-aramid fibers, yarns, and/or fabric. At least one of the first flame resistant fabric layer and the second flame resistant fabric layer is formed of yams including a flame resistant 88/12 cotton/nylon blend. The flame resistant composite fabric is incorporated in a fabric garment. The barrier layer includes one or more adhesive layers. The one or more adhesive layers may include a chemical additive selected from brominated aromatic chemical (e.g., decabromodiphenyl oxide (DBDPO) and/or penta bromo phenyl, etc.), antimony trioxide, and blends thereof. Alternatively, or in additional, the one or more adhesive layers may include a base polymer (e.g., acrylic, polyurethane, etc.) and a cross-linking agent (e.g., melamine). Alternatively, or in additional, the one or more adhesive layers may include an inherently flame resistant polymer (e.g., polyvinylchloride (PVC)). The barrier layer includes a membrane layer. The barrier layer may also include adhesive layers that bond the membrane layer to the first and second flame resistant fabric layers. The adhesive layers may include a chemical additive selected from brominated aromatic chemical (e.g., decabromodiphenyl oxide (DBDPO), penta bromo phenyl, etc.), antimony trioxide, and blends thereof. Alternatively, or in additional, the adhesive layers may include a base polymer (e.g., acrylic, polyurethane, etc.) and a cross-linking agent (e.g., melamine). Use of a relatively high level of cross-linking agent with a thermoplastic polymer binder/adhesive may cause the thermoplastic polymer binder/adhesive to resemble thermosetting polymer. In some cases, the adhesive layers may include an inherently flame resistant polymer, such as polyvinylchloride (PVC). The flame retardant composite fabric has a controlled air permeability of about 0 ft³/ft²/min to about 200 ft³/ft²/min, tested according to ASTM D-737 under a pressure difference of ½ inch of water across the flame retardant composite fabric. At least one of the first and second flame resistant fabric layers has a raised surface. The first flame resistant fabric layer has an exposed, raised surface. The first flame resistant fabric layer has a weight of about 3 oz/yd² to about 12 oz/yd². The second flame resistant fabric layer has a weight of about 3 oz/yd² to about 12 oz/yd². The barrier layer has a weight of about 2 g/m² to about 12 g/m². The first (inner) flame resistant fabric layer defines one or more raised inner surface regions, facing towards the wearer, e.g., in the form of a pattern selected to generate a channeling effect, the pattern having the form, e.g., of a grid or box. The second (outer) flame resistant fabric layer is an outer woven layer.

Embodiments can provide one or more of the following advantages.

The flame resistant composite fabrics of the disclosure offer protection from electric arc and/or flash fire hazards.

The flame resistant composite fabric of the disclosure has a laminated membrane/film/adhesive stabilized by a high level of cross-linking, to reduce thermal shrinking (at 500° F. for 5 minutes).

Alternatively, or in addition, the first and/or second flame resistant fabric layer is a knit or woven fabric where the fiber component(s) will have low shrinkage when exposed to heat (at 500° F. for 5 minutes). Fibers of a few materials such as m-aramid and p-aramid meet this requirement. It will be preferred to use these fibers, or fiber blends, in the stitch yarns of knit fabrics (which controls the dimensional stability when exposed to high heat) or in woven fabrics (warp and fill).

The raised surface of the knit construction (velour, or grid or box pattern) will be made of the same flame retardant fiber blend as the stitch or other flame retardant yarns, e.g. flame resistant (FR) treated cotton, flame resistant treated cotton/nylon fiber blends, meta-aramid, and/or para-aramid fibers, yarns, and/or fabric; or modacrylic fibers, yarns and/or fabric; or blends of same.

It will be preferred not to use thermoplastic fibers, like nylon or flame retardant polyester, in the above fiber blend, or at best to use a very small percentage of such fibers in the fiber blend.

Other aspects, features, and advantages are in the description, drawings, and claims.

### DESCRIPTION OF DRAWINGS

FIG. 1 is a front perspective view of a flame resistant composite fabric garment.

FIG. 2 is an end section view of a flame resistant composite fabric.

FIG. 3 is a side section view illustrating formation of a flame resistant composite fabric of the disclosure.

FIG. 4 is a side section view illustrating formation of a second embodiment of the flame resistant composite fabric of the disclosure.

FIG. 5A is a side section view illustrating formation of a third embodiment of the flame resistant composite fabric of the disclosure.

FIG. 5B illustrates the effects of controlled stretching on the flame resistant composite fabric of FIG. 5A.

Like reference symbols in the various drawings indicate like elements.

### DETAILED DESCRIPTION

This disclosure relates to flame resistant composite fabrics for use in safety apparel. The composite fabrics include a face fabric (an outer fabric layer) made from a flame resistant (or inherently flame resistant) woven or knit fabric that is permanently bonded with a flame resistant chemistry (e.g., adhesive and additive) to an inner fabric (inner fabric layer) made from a flame resistant woven or knit fabric. The resulting composite meets the flame resistant testing requirements for wearer protection from electric arc flash. Through the selection of materials and processes, the resulting composite can also be adapted to provide a wide range of air permeability.

As used herein, “aramid” as used herein refers to a polyamide wherein at least 85% of the amide (—COHN—) linkages are attached directly to two aromatic rings. Suitable aramid fibers are described in Man-Made Fibers—Science and Technology, Volume 2, section titled: “Fiber-Forming Aromatic Polyamides”, page 297, W. Black et al., Interscience Publishers, 1968, the complete disclosure of which is incorporated herein by reference. Aramid fibers are also described in U.S. Pat. Nos. 4,172,938; 3,869,429; 3,819,587; 3,673,143; 3,354,127; and 3,094,511, the complete disclosures of which are also incorporated herein by reference. M-aramids are those aramids where the amid linkages are in the meta-position relative to each other, and p-aramids are those aramids where the amid linkages are in the para-position relative to each other.

As used herein, “flame resistant treated cotton” and “flame resistant (FR) treated cotton blends” such as 88/12 as used herein refer to cotton/nylon or 100% cotton containing fabrics that have been treated with flame resistant chemistry to impart flame retardance. These fabrics have in effect been “treated” to impart FR performance. The two common approaches to treating such fabrics are to bind phosphorus based chemistry to cellulose via use of an ammoniation chamber or via thermal treatment conducted on a thermosol finishing range. As used herein, a “thermosol finishing range” refers to a heated oven that employs dry heat at temperatures ranging from about 175° C. to 230° C. to perform thermosoling. “Thermosoling” as used herein is a process of chemically treating fabrics in which a chemical is diffused and fixed inside the fiber by means of dry heat.

The term “flame resistant fabric,” as used herein, refers to a desired protective layer that has been woven, knitted or otherwise assembled using one or more different types of yarn that are either inherently flame resistant or are treated in fabric form to make them flame resistant. The term “flame resistant composite fabric” as used herein refers to composite fabric created via bonding two or more layers of flame resistant fabrics together without the use of sewing, stitchbonding, quilting, or other processes that utilize a stitch or interlace yarn to combine two or more fabric layers.

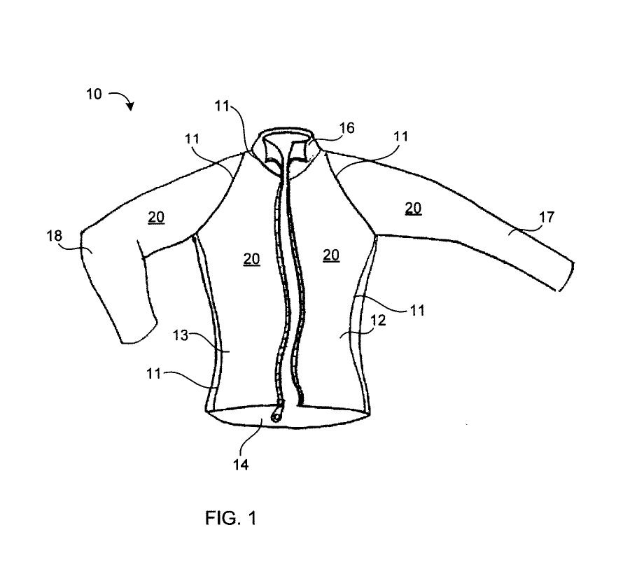

FIG. 1 illustrates a flame resistant composite fabric garment 10 that offers the wearer protection from electric arc and flame hazards. The flame resistant composite fabric garment 10 is formed from a plurality of fabric elements that are joined together by stitching at seams 11. The fabric elements include left and right front elements 12, 13, a rear element 14, a collar element 16, and left and right arm elements 17, 18. Each of these fabric elements is formed of flame resistant (FR) composite fabric.

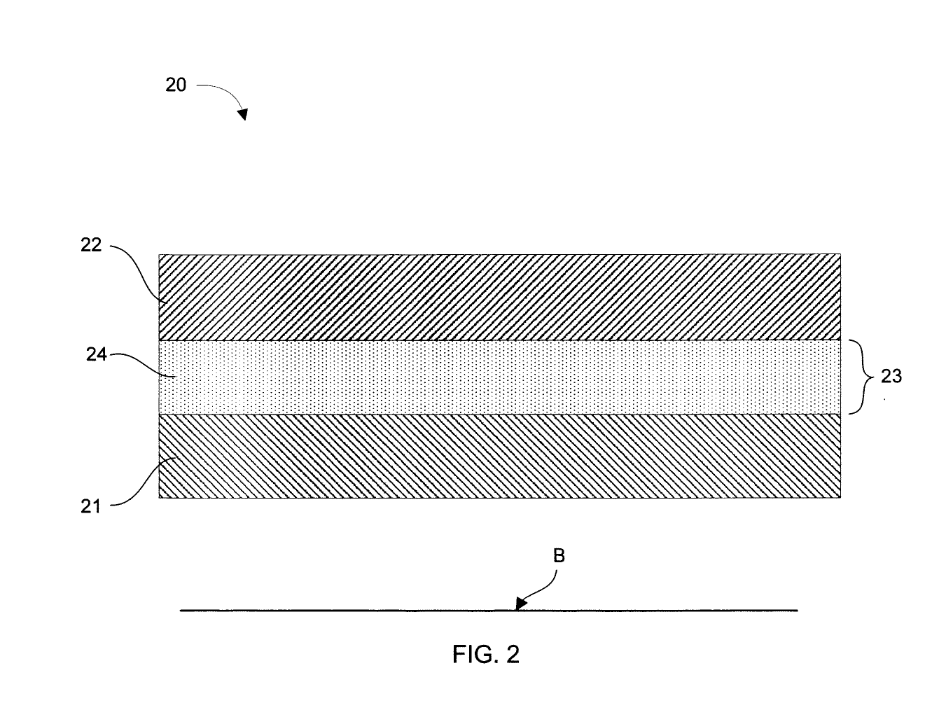

FIG. 2 illustrates a flame resistant composite fabric 20 suitable for forming the fabric elements. The flame resistant composite fabric 20 consists of a first (inner) fabric layer 21, which forms an inner surface of the fabric garment 10 (FIG. 1) worn towards a user's body, B; and a second (outer) flame resistant fabric layer 22, which forms an outer surface of the fabric garment 10. The first and second flame resistant fabric layers 21, 22 are permanently bonded together via a flame resistant (FR) barrier layer 23 that has a flame resistant chemistry that allows the resulting composite fabric 20 to meet the performance requirements of one or more of the following National Fire Protection Association (NFPA) standards: NFPA 70E HRC2 or HRC3 (2009 ed.), NFPA 1975 (2009 ed.), NFPA 1977 (2005 ed.), NFPA 1951 (2007 ed.), and/or NFPA 2112 (2007 ed.). The entire disclosure of each of the abovementioned National Fire Protection Association (NFPA) standards are incorporated herein by reference.

The flame retardant composite fabric has an air permeability of about 0 ft³/ft²/min to about 200 ft³/ft²/min, tested according to ASTM D-737 under a pressure difference of ½ inch of water across the flame retardant composite fabric. The entire disclosure of ASTM D-737 is incorporated herein by reference. The air permeability of the flame resistant composite fabric can be controlled via the selection of materials used for the first and second flame resistant fabric layers 21, 22, and the flame retardant barrier layer 23. Referring to FIG. 2, the first flame resistant fabric layer 21 consists of flame resistant fabric. The first (inner) flame resistant fabric layer 21 can, for example, have a construction selected from among, e.g., woven construction having one-way stretch, with or without raised surface; woven construction having two-way stretch, with or without raised surface; knit construction (e.g., circular or warp knit) with or without raised surface (e.g., fleece (lofted) and jersey (flat) knits). The first (inner) flame resistant fabric layer 21 has a weight of about 3 ounces per square yard to about 12 ounces per square yard, and is formed of flame resistant and/or flame resistant treated fibers, yarns, or fabrics selected from flame resistant (FR) treated cotton, FR treated cotton/nylon blends (e.g., 88/12 cotton/nylon), meta-aramid, para-aramid, and/or other inherent FR or FR treated fibers, yarns, and fabrics, e.g., including modacrylic fibers, yarns, and fabrics. In some cases, the first (inner) flame resistant fabric layer 21 can define one or more raised inner surface regions, i.e. facing towards the wearer, in the form of a pattern, such as grid, box, etc., selected to generate a channeling effect, e.g. as described in U.S. application Ser. No. 10/047,939, filed Oct. 23, 2001, now U.S. Pat. No. 6,927,182, issued Aug. 9, 2005, the entire disclosure of which are incorporated herein by reference.

Referring still to FIG. 2, the second (outer) flame resistant fabric layer 22 consists of a woven or knit (e.g., warp knit or circular knit) flame resistant fabric. Suitable woven fabrics for the second flame resistant fabric layer 22 can be comprised of flame resistant treated cotton fabric or cotton blends such as “88/12” cotton/nylon. Woven fabrics comprised of 100% aramid, aramid blends, and other flame resistant fabrics may also be used. The second flame resistant fabric layer 22 weighs about 3 ounces per square yard to about 12 ounces per square yard, and is formed of flame resistant (FR) treated cotton, FR treated cotton/nylon blends (e.g., 88/12 cotton/nylon), meta-aramid, para-aramid, and/or other inherent FR or FR treated yarns and/or fibers, including, e.g., modacrylic yarns and/or fibers. The second (outer) flame resistant fabric layer 22 may have stretch in at least one direction, e.g., one-way stretch in the width (wale) direction or two-way stretch including stretch in both the width (wale) and the length (course) direction. Alternatively, the second flame resistant fabric layer 22 may be formed from a low stretch or no stretch fabric. The second flame resistant fabric layer 22 can have inherent wind breaking property. The air permeability can be reduced further when the second (outer) flame resistant fabric layer is combined with the barrier layer.

Examples of suitable flame resistant fabrics that can be used as the first (inner) flame retardant fabric layer and/or the second flame retardant (outer) fabric layer are described in U.S. Pat. No. 6,828,003, issued Dec. 7, 2004, the entire disclosure of which is incorporated herein by reference.

As mentioned above, the flame retardant barrier layer 23 is positioned between and permanently bonds the first and second flame resistant fabric layers 21, 22. The flame retardant barrier layer 23 includes an adhesive 24 capable of withstanding exposure to a temperature of 500° F. for 5 minutes without changing the integrity of the composite fabric 20 such as by delamination, separation, shrinking, cracking, etc., as described in the ISO 17493 “Clothing and equipment for protection against heat—Test method for convective heat resistance using a hot air circulating oven” test method requirements, the entire disclosure of which is incorporated herein by reference. Suitable adhesives may include adhesives with low shrinkage at high temperatures, cross-linked adhesives, thermosetting adhesives (1, 2 or 3 component). The adhesive 24 may, in one form, be applied by means of transfer coating from release paper at between 0.25 oz/yd² and 2.5 oz/yd².

The adhesive 24 can be inherently flame resistant, such as a polyvinyl chloride (PVC) based adhesive. Alternatively or additionally, the adhesive 24 can include one or more chemical additives selected from brominated aromatic chemical (e.g., decabromodiphenyl oxide (DBDPO), penta bromo phenyl, etc.), antimony trioxide, and blends thereof, which result in the creation of a flame retardant composite fabric suitable for protection from electric arc and flash fire hazards. In some embodiments, for example, the flame retardant barrier layer 23 includes a polyurethane-based adhesive with an additive system that consists of a blend of DBDPO and antimony trioxide.

Alternatively, or in additional, the adhesive 24 can include a base polymer (e.g., acrylic, polyurethane, etc.) and a cross-linking agent, such as melamine. A relatively high level of cross-linking agent will turn the thermoplastic polymer binder/adhesive to a very stable chemical that may resemble thermosetting polymer.

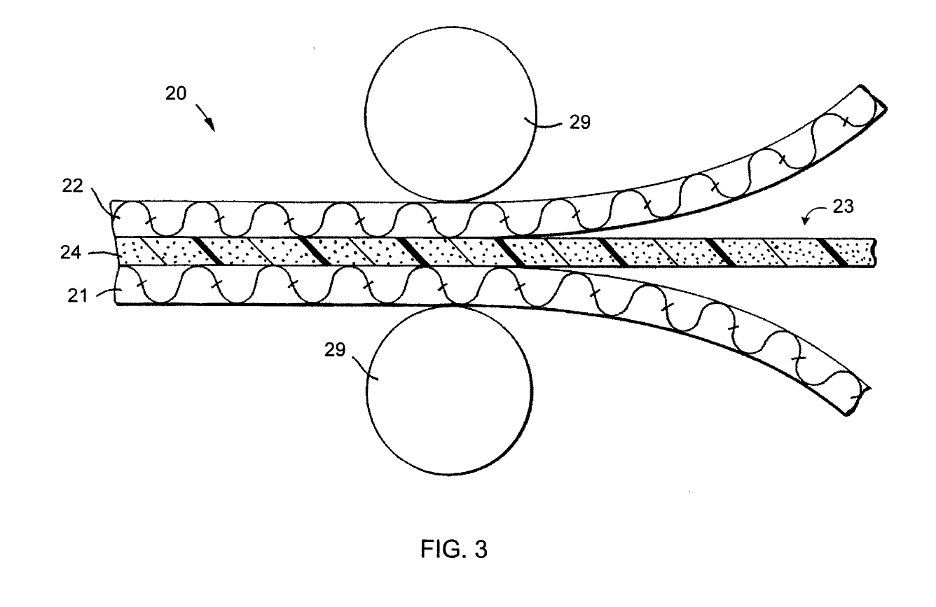

Air permeability can be provided and controlled by applying the adhesive 24 as a continuous layer, and then mechanically modifying the layer of adhesive such as by crushing or stretching. For example, referring to FIG. 3, air permeability can be controlled by applying the adhesive on the fabric and then using some type of mechanical processing, such as treatment with rollers 19, in order to create the desired levels of air permeability.

Still referring to FIG. 3, adhesive 24 may be applied by means of a release paper, wherein the adhesive is first placed on release paper at between about 0.25 oz/yd² and 2.5 oz/yd², after which one of the fabric layers is placed on top of the adhesive in order for bonding to occur between an opposed first surface of the adhesive layer and the fabric layer. The release paper is then stripped from the fabric and the second flame resistant fabric layer is applied to the surface of the adhesive. The composite then undergoes mechanical processing through opposed rollers 29 (which may be heated to a temperature of between about 100° F. and 375° F.), which apply pressure to the composite fabric. As can be appreciated, by changing any mechanical parameter (roller temperature, pressure applied, and speed of the fabric through the rollers), the air permeability characteristics of the composite fabric can also be modified.

Alternatively, and still referring to FIG. 3, adhesive 24 may be applied directly to one of fabric layers 21 and 22 (at 0.25 oz./yd.² to 2.5 oz./yd.²) without the use of release paper. As before, the composite fabric will undergo mechanical processing in order to achieve desired air permeability performance.

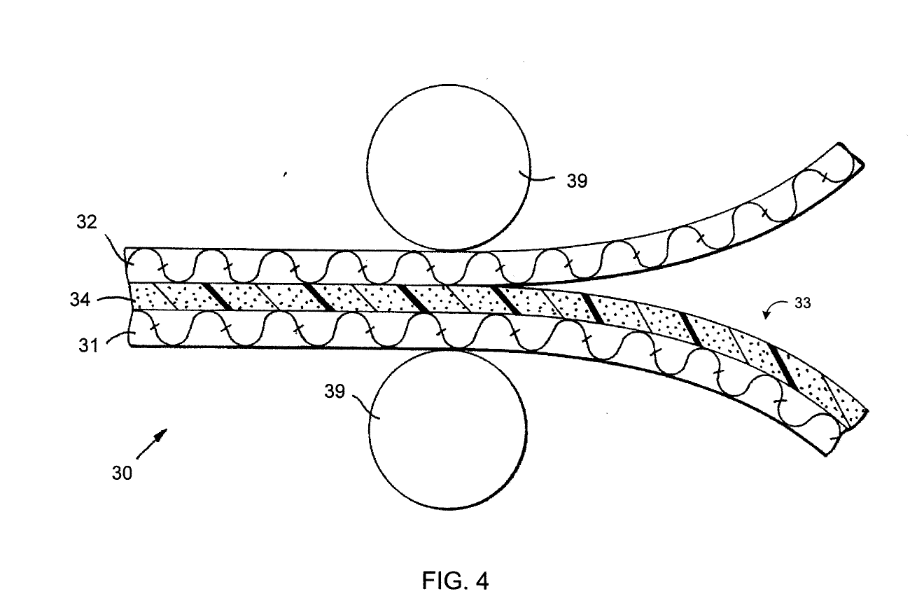

Alternatively, foamed adhesive can be used to provide air permeability. Referring now to FIG. 4, another embodiment of the inventive flame retardant composite fabric is shown and generally indicated at 30. The flame retardant composite fabric 30 includes first and second flame resistant fabric layers 31 and 32, and a barrier layer 33 consisting of an intermediate adhesive 34. The barrier layer 33 is capable of withstanding exposure to a temperature of 500° F. for 5 minutes without changing the integrity of the composite fabric 20, such as by delamination, separation, shrinking, cracking, etc. The first and second flame resistant fabric layers 31 and 32 both have flame resistant woven or knit construction, such as described above with reference to FIG. 2.

The adhesive 34 can be inherently flame resistant, such as a polyvinyl chloride (PVC) based adhesive. Alternatively, or in additional, the adhesive 34 can include one or more chemical additives selected from brominated aromatic chemical (e.g., decabromodiphenyl oxide (DBDPO), penta bromo phenyl, etc.), antimony trioxide, and blends thereof, which result in the creation of a flame retardant composite fabric that is suitable for protection from electric arc and flash fire hazards. In some embodiments, for example, the barrier layer 33 consists of a polyurethane-based adhesive that includes flame retardant additives that consist of a blend of DBDPO and antimony trioxide.

Alternatively, or in additional, the adhesive 34 can include a base polymer (e.g., acrylic, polyurethane, etc.) and a cross-linking agent, such as melamine.

The chemical makeup of the adhesive 34 can help to provide a flame retardant composite fabric that is suitable for protection from electric arc and/or flash fire hazards in accordance with one or more of the following National Fire Protection Association (NFPA) standards: NFPA 70E HRC2 or HRC3 (2009 ed.), NFPA 1975 (2009 ed.), NFPA 1977 (2005 ed.), NFPA 1951 (2007 ed.), and/or NFPA 2112 (2007 ed.). Here, the adhesive 34 is applied as foam at between about 0.3 oz/yd² and 10 oz/yd². The foam density (mixing air with adhesive) and the amount of adhesive applied are selected depending on the desired air permeability of the flame retardant composite fabric 30. The flame retardant composite fabric 30 is prepared by first applying foam adhesive 34 on one of the opposed surfaces of fabric layers 31 and 32. Once the adhesive is applied, the other fabric layer is placed upon the adhesive in order to produce the flame retardant fabric composite of the disclosure. The flame retardant composite fabric 30 is then mechanically processed by means of a pair of rollers 39, which apply pressure thereto in an amount between about 10 lbs./in.² and 150 lbs/in.² in order to produce a composite having a specific level of air permeability.

Air permeability can also be provided by applying the adhesive, e.g., via rotary printing and/or gravure rolling, in a discontinuous pattern, such as in a dot coating pattern.

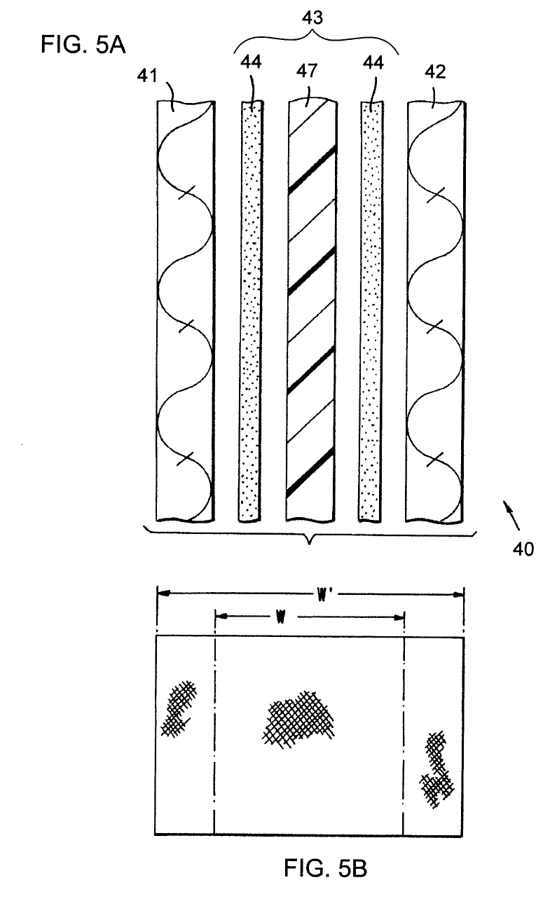

FIG. 5A illustrates yet another embodiment of the inventive flame retardant composite fabric of this disclosure, which is generally indicated at 40. The flame retardant composite fabric 40 includes first and second flame resistant fabric layers 41 and 42, both of which have a flame resistant woven or knit construction such as described above with reference to FIG. 2. The flame retardant composite fabric 40 also includes a barrier layer 43 capable of withstanding exposure to a temperature of 500° F. for 5 minutes without changing the integrity of the composite fabric 40 such as by delamination, buckling, etc. The FR barrier layer 43 may consist of a membrane layer 47 disposed between two adhesive layers 44 for adhering the membrane layer 47 between the first and second FR fabric layers 41, 42.

The adhesive layers 44 can be inherently flame resistant, such as a polyvinyl chloride (PVC) based adhesive. Alternatively, or in additional, the adhesive layers 44 can include one or more chemical additives selected from brominated aromatic chemical (e.g., decabromodiphenyl oxide (DBDPO), penta bromo phenyl, etc.), antimony trioxide, and blends thereof, which result in the creation of a flame retardant composite fabric suitable for protection from electric arc and flash fire hazards. In some embodiments, for example, the adhesive layers 44 consist of a polyurethane based adhesive that includes a flame retardant additive system that includes a blend of DBDPO and antimony trioxide.

Alternatively, or in additional, the adhesive layers 44 can include a base polymer (e.g., acrylic, polyurethane, etc.) and a cross-linking agent, such as melamine.

The adhesive layers 44 may be applied by means of transfer coating from release paper at a thickness of between 0.25 oz/yd² and 2.5 oz/yd². The membrane layer 47 can consist of: film, such as full film; breathable membrane; hydrophobic porous membrane; or non-porous hydrophilic membrane with very high water resistance. Examples of suitable membranes are described in U.S. patent application Ser. No. 12/368,225, filed Feb. 9, 2009 (U.S. Patent Publication No. 2009-0197491, published Aug. 6, 2009), U.S. patent application Ser. No. 12/494,070, filed Jun. 29, 2009 (U.S. Patent Publication No. 2009-0260126, published Oct. 22, 2009), and U.S. patent application Ser. No. 11/001,893, filed Dec. 1, 2004 (U.S. Patent Publication No. 2005-0097652, published May 12, 2005), the entire disclosure of each of which is incorporated herein by reference. The membrane layer 47 may be applied by means of transfer coating from release paper at a thickness of between 0.0001 in. and 0.010 in., or directly on the fabric surfaces at a thickness of between 0.0003 in. and 0.010 in.

As shown in FIG. 5B, the composite fabric 40 having a width, W, is subjected to controlled stretching to produce a composite having a width, W′, with a desired predetermined level of air permeability.

The membrane layer 47 can also be made of electrospun membrane with good water resistance and controlled air permeability. The air permeability can be controlled via the fineness of the electrospun fibers, which may be about 100 nm to about 1,000 nm in diameter. The electrospun membrane can have a weight of about 2 g/m² to about 15 g/m². Examples of suitable electrospun membranes are described in U.S. patent application Ser. No. 12/354,986, filed Jan. 16, 2009 (U.S. Patent Publication No. 2009-0186548, published Jul. 23, 2009), the entire disclosure of which is incorporated herein by reference.

The various layers can be bonded together as described using one or more of the adhesive application and bonding processes described in U.S. patent application Ser. No. 12/354,986, filed Jan. 16, 2009 (U.S. Patent Publication No. 2009-0186548, published Jul. 23, 2009) and U.S. patent application Ser. No. 12/368,225, filed Feb. 9, 2009 (U.S. Patent Publication No. 2009-0197491, published Aug. 6, 2009), the entire disclosure of each of which is incorporated herein by reference.

### Test Methods

### Arc Resistance Test

The arc resistance of the composite fabrics of the disclosure is determined in accordance with ASTM F-1959-99 “Standard Test Method for Determining the Arc Thermal Performance Value of Materials for Clothing,” the entire disclosure of which is incorporated herein by reference. The flame resistant composite fabrics of the disclosure have an arc resistance of at least 0.8 calories, e.g., at least 1.2 calories per square centimeter per ounce per square yard (osy).

### Vertical Flame Test

The char length of the composite fabrics of the disclosure is determined in accordance with ASTM D-6413-99 “Standard Test Method for Flame Resistance of Textiles (Vertical Method),” the entire disclosure of which is incorporated herein by reference.

### Thermal Protective Performance (TPP)

A 6 inch square fabric specimen is suspended horizontally in a holder over two Meker burners and a radiant panel. Weighted sensors placed on top of the fabric (contact) and 6 mm away (spaced) measure the amount of time required for heat penetrating through the fabric to reach a temperature necessary to cause a 2^{nd}-degree burn. This time is multiplied by the exposure heat flux to yield a TPP rating. The resulting measurement corresponds to the amount of time that passes until the wearer suffers a 2^{nd} degree burn.

### Thermal Shrinkage and Heat Resistance

A 15 inch square specimen that has been washed three times is marked for length and width and suspended in an air-circulating oven at 500° F. for five minutes, and the degree of shrinkage is calculated. For determination of heat resistance, the fabric sample is examined for melting, dripping, separation, or ignition.

### Instrumented Mannequin

The fabric specimen formed into a size 42 regular coverall garment with specific trim and pocketing configuration is placed on an instrumented mannequin dressed in cotton underwear. The mannequin is subjected to overall heat and flame exposure for three seconds. Sensors embedded in the mannequin predict whether a 2^{nd} or 3^{rd} degree burn will occur at that location and a percent body rating is calculated.

A number of embodiments of the disclosure have been described. Nevertheless, it will be understood that various modifications may be made without departing from the spirit and scope of the disclosure. Accordingly, other embodiments are within the scope of the following claims.

What is claimed is:

1. A flame resistant composite fabric comprising:
a first flame resistant fabric layer;
a second flame resistant fabric layer; and
a barrier layer bonding the first flame resistant fabric layer to the second flame resistant fabric layer,
wherein the barrier layer is capable of withstanding temperature of 500° F. for at least 5 minutes without substantial change in the integrity of the flame resistant composite fabric.

2. The flame resistant composite fabric of claim 1, wherein at least one of the first flame resistant fabric layer and the second flame resistant fabric layer is formed of inherent flame resistant fibers, yarns, and/or fabric.

3. The flame resistant composite fabric of claim 1, wherein at least one of the first flame resistant fabric layer and the second flame resistant fabric layer is formed of flame resistant treated fibers, yarns, and/or fabric.

4. The flame resistant composite fabric of claim 1, wherein at least one of the first flame resistant fabric layer and the second flame resistant fabric layer is formed of flame resistant (FR) treated cotton, flame resistant treated cotton/nylon fiber blends, meta-aramid, and/or para-aramid fibers, yarns, and/or fabric.

5. The flame resistant composite fabric of claim 1, wherein at least one of the first flame resistant fabric layer and the second flame resistant fabric layer is formed of modacrylic fibers, yarns, and/or fabric alone.

6. The flame resistant composite fabric of claim 1, wherein at least one of the first flame resistant fabric layer and the second flame resistant fabric layer is formed of modacrylic fibers, yarns, and/or fabric in a blend with one or more of flame resistant (FR) treated cotton, flame resistant treated cotton/nylon fiber blends, meta-aramid, and/or para-aramid fibers, yarns, and/or fabric.

7. The flame resistant composite fabric of claim 1, wherein at least one of the first flame resistant fabric layer and the second flame resistant fabric layer is formed of yarns comprising a flame resistant 88/12 cotton/nylon blend.

8. The flame resistant composite fabric of claim 1, incorporated in a fabric garment.

9. The flame resistant composite fabric of claim 1, wherein the barrier layer comprises one or more adhesive layers.

10. The flame resistant composite fabric of claim 9, wherein the one or more adhesive layers includes a chemical additive selected from brominated aromatic chemical, antimony trioxide, and blends thereof.

11. The flame resistant composite fabric of claim 10, wherein the brominated aromatic chemical is selected from decabromodiphenyl oxide (DBDPO) and penta bromo phenyl.

12. The flame resistant composite fabric of claim 9, wherein the one or more adhesive layers include a base polymer and a cross-linking agent.

13. The flame resistant composite fabric of claim 12, wherein the one or more adhesive layers include a thermoplastic polymer binder/adhesive and a relatively high level of cross-linking agent causing the thermoplastic polymer binder/adhesive to resemble thermosetting polymer.

14. The flame resistant composite fabric of claim 12, wherein the base polymer is selected from acrylic and polyurethane.

15. The flame resistant composite fabric of claim 12, wherein the cross-linking agent is melamine.

16. The flame resistant composite fabric of claim 9, wherein the one or more adhesive layers include an inherently flame resistant polymer.

17. The flame resistant composite fabric of claim 16, wherein the inherently flame resistant polymer is polyvinylchloride (PVC).

18. The flame resistant composite fabric of claim 1, wherein the barrier layer comprises a membrane layer.

19. The flame resistant composite fabric of claim 18, wherein the barrier layer comprises adhesive layers which bond the membrane layer to the first and second flame resistant fabric layers.

20. The flame resistant composite fabric of claim 19, wherein the adhesive layers include a chemical additive selected from brominated aromatic chemical, antimony trioxide, and blends thereof.

21. The flame resistant composite fabric of claim 20, wherein the brominated aromatic chemical is selected from decabromodiphenyl oxide (DBDPO) and penta bromo phenyl.

22. The flame resistant composite fabric of claim 19, wherein the adhesive layers include a base polymer and a cross-linking agent.

23. The flame resistant composite fabric of claim 22, wherein the base polymer is selected from acrylic and polyurethane.

24. The flame resistant composite fabric of claim 22, wherein the cross-linking agent is melamine.

25. The flame resistant composite fabric of claim 19, wherein the adhesive layers include an inherently flame resistant polymer.

26. The flame resistant composite fabric of claim 25, wherein the inherently flame resistant polymer is polyvinylchloride (PVC).

27. The flame resistant composite fabric of claim 1, wherein at least one of the first and second flame resistant fabric layers has a raised surface.

28. The flame retardant composite fabric of claim 1, wherein the flame retardant composite fabric has a controlled air permeability of about 0 ft³/ft²/min to about 200 ft³/ft²/min, tested according to ASTM D-737 under a pressure difference of ½ inch of water across the flame retardant composite fabric.

29. The flame resistant composite fabric of claim 1, wherein the first flame resistant fabric layer has an exposed, outer raised surface.

30. The flame resistant composite fabric of claim 1, wherein the first flame resistant fabric layer has a weight of about 3 oz/yd² to about 12 oz/yd².

31. The flame resistant composite fabric of claim 1, wherein the second flame resistant fabric layer has a weight of about 3 oz/yd² to about 12 oz/yd².

32. The flame resistant composite fabric of claim 1, wherein the barrier layer has a weight of about 2 g/m² to about 12 g/m².

33. The flame resistant composite fabric of claim 27, wherein the first (inner) flame resistant fabric layer defines one or more raised inner surface regions, facing towards the wearer, in the form of a pattern selected to generate a channeling effect.

34. The flame resistant composite fabric of claim 33, wherein the pattern selected to generate a channeling effect has the form of a grid or box.

35. The flame resistant composite fabric of claim 1, wherein the second (outer) flame resistant fabric layer is an outer woven layer.

36. A flame resistant composite fabric comprising:
a first flame resistant fabric layer;
a second flame resistant fabric layer; and
a barrier layer bonding the first flame resistant fabric layer to the second flame resistant fabric layer, wherein the flame resistant composite fabric offers protection from electric arc flash hazards and/or from flash fire hazards in accordance with one or more of the following Nation Fire Protection Association standards: NFPA 70E (2009 ed.), NFPA 1975 (2009 ed.), NFPA 1977 (2005 ed.), NFPA 1951 (2007 ed.), and NFPA 2112 (2007 ed.).

37. The flame resistant composite fabric of claim 36, wherein at least one of the first flame resistant fabric layer and the second flame resistant fabric layer is formed of inherent flame resistant fibers, yarns, and/or fabric.

38. The flame resistant composite fabric of claim 36, wherein at least one of the first flame resistant fabric layer and the second flame resistant fabric layer is formed of flame resistant (FR) treated cotton, flame resistant treated cotton/nylon fiber blends, meta-aramid, and/or para-aramid fibers, yarns, and/or fabric.

39. The flame resistant composite fabric of claim 36, wherein at least one of the first flame resistant fabric layer and the second flame resistant fabric layer is formed of modacrylic fibers, yarns, and/or fabric alone.

40. The flame resistant composite fabric of claim 36, wherein at least one of the first flame resistant fabric layer and the second flame resistant fabric layer is formed of modacrylic fibers, yarns, and/or fabric in a blend with one or more of flame resistant (FR) treated cotton, flame resistant treated cotton/nylon fiber blends, meta-aramid, and/or para-aramid fibers, yarns, and/or fabric.

41. The flame resistant composite fabric of claim 36, wherein at least one of the first flame resistant fabric layer and the second flame resistant fabric layer is formed of yarns comprising a flame resistant 88/12 cotton/nylon blend.

42. The flame resistant composite fabric of claim 36, incorporated in a fabric garment.

43. The flame resistant composite fabric of claim 36, wherein the barrier layer comprises one or more adhesive layers.

44. The flame resistant composite fabric of claim 43, wherein the one or more adhesive layers includes a chemical additive selected from brominated aromatic chemical, antimony trioxide, and blends thereof.

45. The flame resistant composite fabric of claim 44, wherein the brominated aromatic chemical is selected from Decabromodiphenyl oxide (DBDPO) and penta bromo phenyl.

46. The flame resistant composite fabric of claim 43, wherein the one or more adhesive layers include a base polymer and a cross-linking agent.

47. The flame resistant composite fabric of claim 46, wherein the base polymer is selected from acrylic and polyurethane.

48. The flame resistant composite fabric of claim 46, wherein the cross-linking agent is melamine.

49. The flame resistant composite fabric of claim 43, wherein the one or more adhesive layers include an inherently flame resistant polymer.

50. The flame resistant composite fabric of claim 49, wherein the inherently flame resistant polymer is polyvinylchloride (PVC).

51. The flame resistant composite fabric of claim 36, wherein the barrier layer comprises a membrane layer.

52. The flame resistant composite fabric of claim 51, wherein the barrier layer comprises adhesive layers which bond the membrane layer to the first and second flame resistant fabric layers.

53. The flame resistant composite fabric of claim 52, wherein the adhesive layers include a chemical additive selected from brominated aromatic chemical, antimony trioxide, and blends thereof.

54. The flame resistant composite fabric of claim 53, wherein the brominated aromatic chemical is selected from Decabromodiphenyl oxide (DBDPO) and penta bromo phenyl.

55. The flame resistant composite fabric of claim 52, wherein the adhesive layers include a base polymer and a cross-linking agent.

56. The flame resistant composite fabric of claim 55, wherein the base polymer is selected from acrylic and polyurethane.

57. The flame resistant composite fabric of claim 55, wherein the cross-linking agent is melamine.

58. The flame resistant composite fabric of claim 52, wherein the adhesive layers include an inherently flame resistant polymer.

59. The flame resistant composite fabric of claim 58, wherein the inherently flame resistant polymer is polyvinylchloride (PVC).

60. The flame retardant composite fabric of claim 36, wherein the flame retardant composite fabric has a controlled air permeability of about 0 ft³/ft²/min to about 200 ft³/ft²/min, tested according to ASTM D-737 under a pressure difference of ½ inch of water across the flame retardant composite fabric.

61. The flame resistant composite fabric of claim 36, wherein at least one of the first and second flame resistant fabric layers has a raised surface.

62. The flame resistant composite fabric of claim 36, wherein the first flame resistant fabric layer has an exposed, outer raised surface.

63. The flame resistant composite fabric of claim 36, wherein the first flame resistant fabric layer has a weight of about 3 oz/yd² to about 12 oz/yd².

64. The flame resistant composite fabric of claim 36, wherein the second flame resistant fabric layer has a weight of about 3 oz/yd² to about 12 oz/yd².

65. The flame resistant composite fabric of claim 36, wherein the barrier layer has a weight of about 2 g/m² to about 12 g/m².

66. The flame resistant composite fabric of claim 61, wherein the first (inner) flame resistant fabric layer defines one or more raised inner surface regions, facing towards the wearer, in the form of a pattern selected to generate a channeling effect.

67. The flame resistant composite fabric of claim 66, wherein the pattern selected to generate a channeling effect has the form of a grid or box.

68. The flame resistant composite fabric of claim 36, wherein the second (outer) flame resistant fabric layer is an outer woven layer.

69. A flame resistant composite fabric comprising:
a first flame resistant fabric layer;
a second flame resistant fabric layer; and
a barrier layer bonding the first flame resistant fabric layer to the second flame resistant fabric layer, wherein the barrier layer comprises an adhesive including a flame retardant additive system comprising a brominated aromatic chemical.

70. The flame resistant composite fabric of claim 69, wherein the brominated aromatic chemical is selected from decabromodiphenyl oxide (DBDPO) and penta bromo phenyl.

71. The flame resistant composite fabric of claim 69, wherein the flame retardant additive system comprises a blend of the brominated aromatic chemical and antimony trioxide.

72. The flame resistant composite fabric of claim 69, wherein the adhesive is a polyurethane based adhesive.

73. The flame resistant composite fabric of claim 69, wherein at least one of the first flame resistant fabric layer and the second flame resistant fabric layer is formed of inherent flame resistant fibers, yarns, and/or fabric.

74. The flame resistant composite fabric of claim 69, wherein at least one of the first flame resistant fabric layer and the second flame resistant fabric layer is formed of flame resistant treated fibers, yarns, and/or fabric.

75. The flame resistant composite fabric of claim 69, wherein at least one of the first flame resistant fabric layer and the second flame resistant fabric layer is formed of flame resistant (FR) treated cotton, flame resistant treated cotton/nylon fiber blends, meta-aramid, and/or para-aramid fibers, yarns, and/or fabric.

76. The flame resistant composite fabric of claim 69, wherein at least one of the first flame resistant fabric layer and the second flame resistant fabric layer is formed of modacrylic fibers, yarns, and/or fabric.

77. The flame resistant composite fabric of claim 69, wherein at least one of the first flame resistant fabric layer and the second flame resistant fabric layer is formed of modacrylic fibers, yarns, and/or fabric in a blend with one or more of flame resistant (FR) treated cotton, flame resistant treated cotton/nylon fiber blends, meta-aramid, and/or para-aramid fibers, yarns, and/or fabric.

78. The flame resistant composite fabric of claim 69, wherein at least one of the first flame resistant fabric layer and the second flame resistant fabric layer is formed of yarns comprising a flame resistant 88/12 cotton/nylon blend.

79. The flame resistant composite fabric of claim 69, incorporated in a fabric garment.

80. The flame resistant composite fabric of claim 69, wherein the barrier layer comprises a membrane layer.

81. The flame resistant composite fabric of claim 80, wherein the adhesive bonds the membrane layer to the first and second flame resistant fabric layers.

82. The flame retardant composite fabric of claim 69, wherein the flame retardant composite fabric has a controlled air permeability of about 0 ft³/ft²/min to about 200 ft³/ft²/min, tested according to ASTM D-737 under a pressure difference of ½ inch of water across the flame retardant composite fabric.

83. The flame resistant composite fabric of claim 69, wherein at least one of the first and second flame resistant fabric layers has a raised surface.

84. The flame resistant composite fabric of claim 69, wherein the first flame resistant fabric layer has an exposed, outer raised surface.

85. The flame resistant composite fabric of claim 69, wherein the first flame resistant fabric layer has a weight of about 3 oz/yd² to about 12 oz/yd².

86. The flame resistant composite fabric of claim 69, wherein the second flame resistant fabric layer has a weight of about 3 oz/yd² to about 12 oz/yd².

87. The flame resistant composite fabric of claim 69, wherein the barrier layer has a weight of about 2 g/m² to about 12 g/m².

88. The flame resistant composite fabric of claim 83, wherein the first (inner) flame resistant fabric layer defines one or more raised inner surface regions, facing towards the wearer, in the form of a pattern selected to generate a channeling effect.

89. The flame resistant composite fabric of claim 88, wherein the pattern selected to generate a channeling effect has the form of a grid or box.

90. The flame resistant composite fabric of claim 69, wherein the second (outer) flame resistant fabric layer is an outer woven layer.
